(19) United States
(12) Patent Application Publication
(10) Pub. No.: US 2025/0098718 A1
(43) Pub. Date: Mar. 27, 2025

(54) POWDERED COMPOSITION

(71) Applicant: Firmenich SA, Satigny (CH)

(72) Inventors: Jian ZHANG, Plainsboro, NJ (US); Howard MUNT, Satigny (CH)

(21) Appl. No.: 18/291,463

(22) PCT Filed: Jul. 25, 2022
(86) PCT No.: PCT/EP22/70767

§ 371 Date: Jan. 23, 2024

Related U.S. Application Data
(60) Provisional application No. 63/235,132, filed on Aug. 19, 2021.

(30) Foreign Application Priority Data
Sep. 22, 2021 (EP) 21198195.6

(51) Int. Cl. A23L 27/10; A21D 2/08; A21D 13/047; A23L 2/39

(52) U.S. Cl. CPC A23L 27/10; A21D 2/08; A21D 13/047; A23L 2/39

(57) ABSTRACT

Described herein is a powdered composition including a carrier including a soluble flour, and at least one active ingredient. Also described herein are a method for preparing the composition and flavored products including the composition.

### TECHNICAL FIELD

The present invention relates to a powdered composition comprising a carrier comprising a soluble flour, and at least one active ingredient. A method for preparing the composition and flavored products comprising the inventive composition are also objects of the present invention.

### BACKGROUND OF THE INVENTION

The consumer demand for “clean label” or “natural” delivery systems is more and more important and is driving therefore the development of new delivery systems. Dried particles are commonly prepared from a liquid emulsion that is then dried via different methods (e.g., spray drying, thin film drying, fluidizing bed drying, etc.). Most of the emulsions comprise a carrier, and an active ingredient, such as flavors or fragrances.

Moreover, traditional carriers such as maltodextrins or modified starches are manufactured by multiple energy intensive processes such as the isolation of starch from flours, the modification of starch, and drying steps to obtain powders. However, it is desirable to use less refined ingredients with lower environmental impact as carrier materials.

However, the substitution of traditional carriers with other carriers, in particular naturally occurring carriers, frequently results in poor retention of the active ingredient such as flavors or fragrances in the carrier material. Additionally, the solubility and/or viscosity of some carrier substitutes also adversely affects the retention of the active ingredient in the carrier material.

In view of the above, there is a constant need for further carrier materials that allow the effective retention of active ingredients (greater than 70%), that are cheap, and that can be produced with less energy intensive processes.

### SUMMARY OF THE INVENTION

The present invention relates to a powdered composition comprising:
a) from 40 to 95% of a carrier comprising a soluble flour, wherein:
   i. the flour has a solubility of greater than or equal to 50% and less than 99%, when measured at a flour concentration of 10% w/w in an aqueous solution;
   ii. the soluble flour has a viscosity of less than or equal to 400 mPa·s, when measured at 65° C. and shear rate of 50 s⁻¹, and a flour concentration of 30% w/w in an aqueous solution; and
b) from 5 to 60% of at least one active ingredient,
   the percentages being defined by weight, relative to the total weight of the composition.

Another aspect of the present invention relates to a method for the preparation of the powdered composition according to the invention, comprising the steps of:
a. partially hydrolyzing a non-soluble flour by endogenous or exogenous enzymatic hydrolysis to obtain a soluble flour;
b. preparing a blend of a carrier comprising the soluble flour obtained in step a), at least one active ingredient, and water;
c. spray-drying or extruding the blend obtained in step b) to obtain the powdered composition.

A further aspect of the present invention relates to a flavored article comprising the composition according to the invention.

### DESCRIPTION OF THE FIGURES

FIG. 1. Flow viscosity of prepared koji rice solutions at different solid content levels.

FIG. 2. Microphotographs under polarized light. Left picture, koji rice flour before thermal treatment; right picture, koji rice after thermal treatment.

FIG. 3. Flow viscosity of prepared koji rice/rice flour solutions after thermal treatment at a solid content of 27%.

### DETAILED DESCRIPTION OF THE INVENTION

Unless stated otherwise, percentages (%) are meant to designate percentage by weight.

The present invention relates to a powdered composition comprising:
a) from 40 to 95% of a carrier comprising a soluble flour, wherein:
   i. the flour has a solubility of greater than or equal to 50% and less than 99%, when measured at a flour concentration of 10% w/w in an aqueous solution;
   ii. the soluble flour has a viscosity of less than or equal to 400 mPa's, when measured at 65° C. and shear rate of 50 s⁻¹, and a flour concentration of 30% w/w in an aqueous solution; and
b) from 5 to 60% of at least one active ingredient,
   the percentages being defined by weight, relative to the total weight of the composition.

In a particular embodiment, the composition comprises from 45 to 95% of the carrier.

In a particular embodiment, the composition comprises from 50 to 80% of the carrier.

According to the invention, the carrier comprises a soluble flour. A flour is considered “soluble” when it meets the solubility requirements given above, i.e. when the flour has a solubility greater than or equal to 50% and less than 99%, when measured at a flour concentration of 10% w/w in an aqueous solution.

Solubility is defined as the weight of soluble solids per 100 grams of flour on a dry weight basis.

In a particular embodiment, the solubility refers to the solubility in an aqueous solution at 25° C., preferably in water, wherein the aqueous solution, preferably water, has a pH value of 7.

In a particular embodiment, the composition comprises a carrier that consists of the soluble flour.

In a particular embodiment, the soluble flour has a solubility greater than or equal to 70% and less than 90%, when measured at a flour concentration of 10% w/w in an aqueous solution.

In a particular embodiment, the soluble flour has a solubility of from 70% to 80% or from 84% to 90%, when measured at a flour concentration of 10% w/w in an aqueous solution.

In a particular embodiment, the solubility of proteins in the soluble flour is higher equal to or higher than 30%. Protein solubility is defined as the weight of soluble proteins per 100 grams of proteins on a dry weight basis.

In a particular embodiment, the soluble flour is selected from the group consisting of soluble corn flour, soluble rice flour, soluble barley flour, soluble oat flour, soluble sorghum flour, soluble wheat flour, soluble defatted pea flour, defatted legume flour, and any mixture thereof.

In a particular embodiment, the soluble flour is soluble rice flour, preferably soluble koji rice flour. Under koji rice, rice is understood that has been fermented with the koji fungus (Aspergillus oryzae).

In a particular embodiment, the soluble flour is soluble wheat flour, preferably soluble koji wheat flour. Under koji wheat, wheat is understood that has been fermented with the koji fungus (Aspergillus oryzae).

In a particular embodiment, the soluble flour is soluble barley flour, preferably soluble koji barley flour. Under koji barley, barley is understood that has been fermented with the koji fungus (Aspergillus oryzae).

Naturally occurring flours usually do not meet the solubility requirements as given above, therefore they have to be processed such that they meet the aforementioned solubility requirements. Typically, naturally occurring flours, i.e. the starch and proteins comprised therein, need to be partially hydrolyzed (i.e. less than 100% hydrolyzed) to meet the solubility and viscosity requirements as given above.

In a particular embodiment, the soluble flour is obtained by partial hydrolysis of a non-soluble flour, preferably by the partial enzymatic hydrolysis of starch and proteins being comprised within a non-soluble flour. The non-soluble flour may be any kind of non-soluble flour, preferably the non-soluble flour is selected from the group consisting of corn flour, rice flour, barley flour, oat flour, sorghum flour, wheat flour, and any mixture thereof.

Preferably, the enzymatic hydrolysis of starch and proteins comprised within the non-soluble flour is conducted in the presence of a carbohydrase such as e.g. an amylase, pullulanase, or glucoamylase, and in the presence of a protease. The aforementioned enzymes may be added to the non-soluble flour to induce the hydrolysis (exogenous hydrolysis) or the enzymes may already have been present in the non-soluble flour (endogenous hydrolysis) and the hydrolysis merely needs to be initiated by a certain trigger such as e.g. a thermal treatment.

In a particular embodiment, the soluble fraction of the soluble flour shows a DE-value of greater than 10, preferably greater than 20.

In a particular embodiment, the soluble fraction of the soluble flour shows a DE-value of from 10 to 30, preferably of from 15 to 25.

The dextrose equivalent (DE) can be determined e.g. by using the method reported in “Y. Rong, M. Sillick, C. M. Gregson. Determination of dextrose equivalent value and number average molecular weight of maltodextrin by osmometry. Journal of Food Science, 2009, 74 (1), pp. C33-C40.)”. Hence, in a particular embodiment, the dextrose equivalent (DE) is determined by osmometry, preferably freezing point osmometry.

The DE-value (dextrose equivalent) is indicative for the degree of polymerization of the starch being comprised in the soluble flour, i.e. the number of monosaccharide units in the soluble flour. The DE-value is calculated as follows:

$$DE = \frac{Reducing sugar in product ( expressed as glucose )}{Total solids content of hydrolyzed starch} \times 100$$

The higher the DE-value, the higher the level of monosaccharide (glucose) and short chain polymers. Glucose (dextrose) possesses a DE-value of 100; the DE-value of untreated (native) starch is approximately zero. Because hydrolyzed starch consists of a mixture of polymers of different lengths, the DE-value is an average value.

The carrier in the powdered composition according to the invention needs to fulfill certain viscosity requirement as defined above. For the measurement of the viscosity, for example, an Anton Paar MCR302 Rheometer (Anton Paar USA Inc., Ashland, VA) may be used.

In a particular embodiment, the soluble flour has a viscosity of from 20 to 400 mPa·s, when measured at 65° C. and shear rate of 50 s⁻¹, and a flour concentration of 30% w/w in an aqueous solution, preferably the soluble flour has a viscosity of from 30 to 300 mPa's at the aforementioned conditions.

In a particular embodiment, the soluble flour has a viscosity of from 15 to 350 mPa·s, when measured at 65° C. and shear rate of 50 s⁻¹, and a flour concentration of 30% w/w in an aqueous solution.

In a particular embodiment, the carrier comprises one type of soluble flour. In another embodiment, the carrier comprises several different types of soluble flours such as e.g. two, three, four, five, or more different types of soluble flour. Preferably, the carrier comprises only one type of soluble flour such as e.g. soluble rice flour.

In a particular embodiment, the carrier comprises a further food material apart from the soluble flour. The further food material may be selected from the group consisting of non-soluble flours, preferably non-soluble rice flour, non-animal proteins, preferably pea protein, soluble fibers, preferably inulin and/or gum arabic, and any mixture thereof.

In an embodiment, the weight ratio of soluble flour to the further food material as defined above, is equal to or higher than 1:1.

In an embodiment, the weight ratio of soluble flour to the further food material as defined above, is from 5:1 to 1:1, preferably the weight ratio is 1:1.

In a particular embodiment, the carrier further comprises non-animal proteins. The non-animal protein may be selected from the group consisting of pea protein, lentil protein, rice protein, potato protein, chickpea protein, fava bean protein, mung bean protein, sunflower seed protein, pumpkin seed protein, flax protein, chia protein, canola protein, lupine protein, alfalfa protein, moringa protein, and any mixture thereof.

In a particular embodiment, the carrier further comprises one or more non-soluble flour(s), preferably non-soluble rice flour.

In a particular embodiment, the carrier further comprises one or more soluble fiber(s), preferably inulin and/or gum arabic.

In a particular embodiment, the carrier is essentially free from modified starch. Under “modified starch” chemically modified starch is meant, e.g. octenyl succinate starches, etc. By “essentially free”, it means that the carrier comprises less than 5%, preferably less than 2%, even more preferably less than 1% by weight based on the total weight of the carrier.

In a particular embodiment, the powdered composition has a glass transition temperature (Tg) of higher than 25° C., preferably higher than 40° C. Having such a glass transition temperature has the advantage that the powdered composition is shelf-stable at room temperature, i.e. it can be stored safely at room temperature.

In a particular embodiment, the powdered composition has a glass transition temperature (Tg) of from 40 to 50° C.

For the measurement of the glass transition temperature, for example, a TA Instruments Differential Scanning calorimeter Q2000 (TA Instruments, New Castle, DE) may be used.

In a particular embodiment, the powdered composition is obtained by spray-drying or extrusion.

In a particular embodiment, the powdered composition further comprises an emulsifier.

According to the invention, the powdered composition comprises at least one active ingredient.

Active ingredients comprise flavoring and/or perfuming ingredients that are preferably subject to oxidation (“oxidizable”) and encompass both flavor and fragrance ingredients or compositions of current use in the flavor and/or fragrance industry, including those of natural or synthetic origin and in the form of single compounds or mixtures thereof. Specific examples of such flavor and/or fragrance ingredients may be found in the current literature, e.g. in Fenaroli's Handbook of flavor ingredients, 1975, CRC Press; Synthetic Food adjuncts, 1947 by M. B. Jacobs, edited by Van Nostrand; or Perfume and Flavor Chemicals by S. Arctander, 1969, Montclair, New Jersey (USA). Many other examples of current flavoring and/or perfuming ingredients may be found in the patent and general literature available. The flavoring and/or perfuming ingredients may be present in the form of a mixture with solvents, adjuvants, additives and/or other components, generally those of current use in the flavor and fragrance industry.

“Flavoring ingredients” as used herein are compounds that are well known to a person skilled in the art of aromatizing as those that are capable of imparting a flavor or taste to a consumer product, or of modifying the taste and/or flavor of the consumer product, or yet its texture or mouthfeel. The flavoring ingredient may be a taste modifier or a taste compound.

Examples of taste compounds are salt, inorganic salts, organic acids, sugars, amino acids and their salts, ribonucleotides, and sources thereof.

A “taste modifier” is understood as an active ingredient that operates on a consumer's taste receptors, or provides a sensory characteristic related to mouthfeel (such as body, roundness, or mouth-coating) to a product being consumed. Non-limiting examples of taste modifiers include active ingredients that enhance, modify or impart saltiness, fattiness, umami, kokumi, heat sensation or cooling sensation, sweetness, acidity, tingling, bitterness or sourness.

The term “perfuming ingredients” is understood to mean compounds, which are used as active ingredients in perfuming preparations or compositions in order to impart a hedonic effect when applied on a surface. In other words, such compounds, to be considered as being perfuming ones, must be recognized by a person skilled in the art of perfumery as being able to impart or modify in a positive or pleasant way the odor of a composition or of an article or surface, and not just as having an odor. Moreover, this definition is also meant to include compounds that do not necessarily have an odor but are capable of modulating the odor of a perfuming composition, perfumed article or surface and, as a result, of modifying the perception by a user of the odor of such a composition, article or surface. It also contains malodor counteracting ingredients and compositions. By the term “malodor counteracting ingredient” we mean here compounds which are capable of reducing the perception of malodor, i.e., of an odor that is unpleasant or offensive to the human nose by counteracting and/or masking malodors. In a particular embodiment, these compounds have the ability to react with key compounds causing known malodors. The reactions result in reduction of the malodor materials' airborne levels and consequent reduction in the perception of the malodor.

Flavors that are derived from or based fruits where citric acid is the predominant, naturally-occurring acid include but are not limited to, for example, citrus fruits (e.g., lemon, lime), limonene, strawberry, orange, and pineapple. In one aspect, the flavors food is lemon, lime or orange juice extracted directly from the fruit. Further aspects of the flavor comprise the juice or liquid extracted from oranges, lemons, grapefruits, key limes, citrons, clementines, mandarins, tangerines, and any other citrus fruit, or variation or hybrid thereof. In a particular aspect, the flavor comprises a liquid extracted or distilled from oranges, lemons, grapefruits, key limes, citrons, clementines, mandarins, tangerines, any other citrus fruit or variation or hybrid thereof, pomegranates, kiwifruits, watermelons, apples, bananas, blueberries, melons, ginger, bell peppers, cucumbers, passion fruits, mangos, pears, tomatoes, and strawberries.

In a particular embodiment, the at least one active ingredient comprises a flavor oil, preferably orange flavor oil.

In a particular embodiment, the powdered composition comprises the at least one active ingredient in an amount of from 5 to 30%, based on the total weight of the composition. In a particular embodiment, the powdered composition comprises the at least one active ingredient in an amount of from 10 to 20%, based on the total weight of the composition. In another embodiment, the powdered composition comprises the at least one active ingredient in an amount of from 6 to 10%, based on the total weight of the composition.

In a particular embodiment, the at least one active ingredient is encapsulated within the carrier. “Encapsulated” means that the at least one active ingredient is entrapped within the carrier matrix. The encapsulation of the active ingredient protects the active ingredient against external influences, such as oxidation.

According to a particular embodiment, the flavor can be encapsulated in a plasmolyzed micro-organism, as described in WO2014/128071A1.

Another aspect of the present invention relates to a method for the preparation of the powdered composition according to the invention, comprising the steps of:
a. partially hydrolyzing a non-soluble flour by endogenous or exogenous enzymatic hydrolysis to obtain a soluble flour;
b. preparing a blend of a carrier comprising the soluble flour obtained in step a), at least one active ingredient, and water;
c. spray-drying or extruding the blend obtained in step b) to obtain the powdered composition.

In step a) of the method according to the invention, a non-soluble flour is partially hydrolyzed by endogenous or exogenous enzymatic hydrolysis to obtain a soluble flour.

In a particular embodiment, in step a), the non-soluble flour is partially hydrolyzed by endogenous enzymatic hydrolysis to obtain the soluble flour.

In a particular embodiment, in step a), the non-soluble flour is partially hydrolyzed by exogenous enzymatic hydrolysis to obtain the soluble flour.

A flour is considered “soluble” when it meets the solubility requirements given above, i.e. when the flour has a solubility greater than or equal to 50% and less than 99%, when measured at a flour concentration of 10% w/w in an aqueous solution. A non-soluble flour thus has a solubility of below 50% at the given conditions.

The non-soluble flour may be any kind of non-soluble flour, preferably the non-soluble flour is selected from the group consisting of corn flour, rice flour, barley flour, oat flour, sorghum flour, wheat flour, and any mixture thereof. More preferably, the non-soluble flour is rice flour, most preferably koji rice flour.

Endogenous enzymatic hydrolysis means that the non-soluble flour is converted to soluble flour by means of enzymes that are inherently (endogenously) present in the non-soluble flour. In other words, no addition of external (exogenous) enzymes to the non-soluble flour is required to hydrolyze starch and proteins comprised in the non-soluble flour. Examples of non-soluble flours that inherently comprise enzymes capable of hydrolyzing starch and proteins are koji rice flour, koji wheat flour, and koji barley flour.

In a particular embodiment, the non-soluble flour in step a) of the method according to the invention is selected from the group consisting of koji rice flour, koji wheat flour, and koji barley flour. Preferably, the non-soluble flour is koji rice flour.

In a particular embodiment, the endogenous enzymatic hydrolysis in step a) is performed by thermally treating a non-soluble flour that endogenously comprises starch-hydrolyzing enzymes and optionally protein-hydrolyzing enzymes, preferably at a temperature of from 50 to 85° C. More preferably, the endogenous enzymatic hydrolysis in step a) is performed at 70° C. Preferably, the thermal treatment is conducted from 1 to 6 hours, more preferably from 2 to 4 hours. Preferably, the thermal treatment is conducted with the non-soluble flour being present in an aqueous solution, more preferably in water.

In a particular embodiment, the thermal treatment for endogenous enzymatic hydrolysis as defined above is followed by an enzyme deactivation step that is preferably conducted at a temperature of from 80 to 100° C., more preferably at a temperature of from 80° C. to 90° C.

By contrast, exogenous enzymatic hydrolysis means that the non-soluble flour is converted to soluble flour by the addition of external enzymes that are capable of hydrolyzing starch and optionally proteins being comprised in the non-soluble flour. Examples for enzymes being capable of hydrolyzing starch are carbohydrases such as amylases, pullulanase, or glucoamylase. Examples for enzymes being capable of hydrolyzing proteins are proteases such as papain, bromelain, fictin, actinidin, zingibain, or cardosins.

In a particular embodiment, the exogenous enzymatic hydrolysis in step a) is performed by adding starch-hydrolyzing enzymes and optionally protein-hydrolyzing enzymes to the non-soluble flour.

During step a) of the method according to the invention, a non-soluble flour is partially hydrolyzed to obtain soluble flour. “Partially hydrolyzed” means that the starch and proteins comprised within the non-soluble flour are not fully (not 100%) hydrolyzed in order to obtain a soluble flour that meets the solubility and viscosity requirements as defined above.

In a particular embodiment, during step b) of the method according to the invention, a blend of the carrier comprising the soluble flour obtained in step a), the at least one active ingredient, and water is prepared that comprises:
from 7.5 to 47.5% of the carrier;
from 0.75 to 30% of the at least one active ingredient; and
from 50 to 85% of water.

The blend obtained in step b) of the method according to the invention can be prepared by means of any known blending method, such as high shear mixing, sonication or homogenization. Such methods are well known to a person skilled in the art.

In a particular embodiment, the blend obtained in step b) of the method according to the invention is an emulsion, preferably an oil-in-water emulsion.

In step c) of the method according to the invention, the blend obtained in step b) is spray-dried or extruded to obtain the powdered composition. Both spray-drying and extrusion are method well known to a person skilled in the art.

In the first alternative of step c), the composition according to the invention is formed by spray-drying the blend, preferably emulsion, obtained in step b), wherein the solid content (the mass of carrier divided by the total mass of carrier and water) is preferably greater than or equal to 20%. One example of a spray-drying method can be found in WO 2019/162475 A1.

In the second alternative of step c), the composition according to the invention is formed by extruding the blend obtained in step b).

Extrusion is a technique used in food processing well known to a skilled person. During extrusion, mixed ingredients are forced through an opening in a perforated plate or die designed to produce the required shape. The extruded food is then cut to a specific size by blades. The machine that forces the mixture of ingredients through the die is referred to as the extruder, and the extruded mixture of ingredients is also known as the extrudate. The extruder is typically a large, rotating screw tightly fitting within a stationary barrel, at the end of which is the die. The extrusion process is described e.g. in US20190289891A1.

Extrusion enables mass production of foods via a continuous, efficient system that ensures uniformity of the final product.

In case, the composition is formed in step c) via extrusion (extrusion encapsulation), the soluble flour obtained in step a) may be spray-dried before being used as ingredient in the preparation of the blend in step b).

In case, the composition is formed in step c) via extrusion (extrusion encapsulation), preferably a twin-screw extruder is used during the extrusion step.

In a particular embodiment, the method according to the invention results in a retention of the at least one active ingredient that is equal to or higher than 80%, preferably of higher than 90%.

In a particular embodiment, the least one active ingredient is a flavor oil and the method according to the invention results in a flavor oil retention that is equal to or higher than 80%, preferably higher than 90%.

The flavor oil retention is calculated as follows: (absolute flavor oil content in the final powdered composition/absolute amount of flavor oil used in the preparation process)×100. The flavor oil retention is indicative on how effective flavor oil can be incorporated into a carrier material.

The oil content in the final powdered composition can be determined e.g. by Time-domain nuclear magnetic resonance (TD-NMR, Minispec mq20, Bruker, Billerica, USA).

Another object of the invention is a consumer product comprising the composition of the invention. Preferably, such a product is a flavored or fragranced product.

In one aspect, the present invention relates to a flavored article comprising the composition according to the invention.

In a particular embodiment, the flavored article is selected from the group consisting of beverage dry mixes, hot beverages, sweet goods, and savory goods.

In a particular embodiment, the flavored article is selected from the group consisting of: protein powders, protein drinks, protein bars, meat analogues, seefood analogues and savory goods.

Meat analogues can include pork analogues, venison analogues, beef analogues, veal analogues, rabbit analogues, sausage analogues, deli meat analogues, ham analogues, salami analogues, pepperoni analogues, chicken analogues, turkey analogues, goose analogues, pheasant analogues, pigeon analogues, whale analogues, lamb analogues, goat analogues, donkey analogues, and squirrel analogues.

Seafood analogues can include fish analogues, scallop analogues, shrimp analogues, crabmeat analogues, shellfish analogues, clam analogues, squid analogues, conch analogues, and sea pineapple analogues.

When the flavored article is a particulate or powdery food, the dry particles may easily be added thereto by dry-mixing. Typical flavored articles are selected from the group consisting of an instant soup or sauce, a breakfast cereal, a powdered milk, a baby food, a powdered drink, a powdered chocolate drink, a spread, a powdered cereal drink, a chewing gum, an effervescent tablet, a cereal bar, and a chocolate bar. The powdered foods or drinks may be intended to be consumed after reconstitution of the product with water, milk and/or a juice, or another aqueous liquid.

The powdered composition provided herein may be suitable for conveying flavors to beverages, fluid dairy products, condiments, baked goods, frostings, bakery fillings, candy, chewing gum and other food products.

Beverages include, without limitation, carbonated soft drinks, including cola, lemon-lime, root beer, heavy citrus (“dew type”), fruit flavored and cream sodas; powdered soft drinks, as well as liquid concentrates such as fountain syrups and cordials; coffee and coffee-based drinks, coffee substitutes and cereal-based beverages; teas, including dry mix products as well as ready-to-drink teas (herbal and tealeaf based); fruit and vegetable juices and juice flavored beverages as well as juice drinks, nectars, concentrates, punches and “ades”; sweetened and flavored waters, both carbonated and still; sport/energy/health drinks; alcoholic beverages plus alcohol-free and other low-alcohol products including beer and malt beverages, cider, and wines (still, sparkling, fortified wines and wine coolers); other beverages processed with heating (infusions, pasteurization, ultra-high temperature, ohmic heating or commercial aseptic sterilization) and hot-filled packaging; and cold-filled products made through filtration or other preservation techniques.

Fluid dairy products include, without limitation, non-frozen, partially frozen and frozen fluid dairy products such as, for example, milks, ice creams, sorbets and yogurts.

Condiments include, without limitation, ketchup, mayonnaise, salad dressing, Worcestershire sauce, fruit-flavored sauce, chocolate sauce, tomato sauce, chili sauce, and mustard.

Baked goods include, without limitation, cakes, cookies, pastries, breads, donuts and the like.

Bakery fillings include, without limitation, low or neutral pH fillings, high, medium or low solids fillings, fruit or milk based (pudding type or mousse type) fillings, hot or cold make-up fillings and nonfat to full-fat fillings.

The composition of the invention can be of particular interest in the following examples of products:
Baked goods (e.g. bread, dry biscuits, cakes, other baked goods),
Cereal products (e.g. breakfast cereals, pre-cooked ready-made rice products, rice flour products, millet and sorghum products, raw or pre-cooked noodles and pasta products),
Milk products (e.g. fresh cheese, soft cheese, hard cheese, milk drinks, whey, butter, partially or wholly hydrolysed milk protein-containing products, fermented milk products, condensed milk and analogues),
Dairy based products (e.g. fruit or flavoured yoghurt, ice cream, fruit ices, frozen desserts)
Dairy analogues (imitation dairy products) containing non-dairy ingredients (plant-based proteins, vegetable fats),
Confectionary products (e.g. chewing gum, hard and soft candy),
Chocolate and compound coatings,
Products based on fat and oil or emulsions thereof (e.g. mayonnaise, spreads, margarines, shortenings, remoulade, dressings, spice preparations),
Spiced, marinated or processed fish products (e.g. fish sausage, surimi),
Eggs or egg products (dried egg, egg white, egg yolk, custard),
Desserts (e.g. gelatins and puddings),
Products made of soya protein or other soya bean fractions (e.g. soya milk and products made therefrom, soya lecithin-containing preparations, fermented products such as tofu or tempeh or products manufactured therefrom, soya sauces),
Vegetable preparations (e.g. ketchup, sauces, processed and reconstituted vegetables, dried vegetables, deep frozen vegetables, pre-cooked vegetables, vegetables pickled in vinegar, vegetable concentrates or pastes, cooked vegetables, potato preparations),
Spices or spice preparations (e.g. mustard preparations, horseradish preparations), spice mixtures and, in particular seasonings which are used, for example, in the field of snacks.
Snack articles (e.g. baked or fried potato crisps or potato dough products, bread dough products, extrudates based on maize, rice or ground nuts),
Ready dishes (e.g. instant noodles, rice, pasta, pizza, tortillas, wraps) and soups and broths (e.g. stock, savory cube, dried soups, instant soups, pre-cooked soups, retorted soups), sauces (instant sauces, dried sauces, ready-made sauces, gravies, sweet sauces).
Extended meat products (e.g. meat patties, sausages, chili, salisbury steaks, pizza toppings, meatballs, ground meat, bolognas, chicken nuggets, pork frankfurters, beef).

### EXAMPLES

### Measurement Methods:

### Flour Solubility Measurement:

Solubility was determined by making up aqueous solutions containing 10% of flour solids (dry basis). Duplicate samples were prepared for each flour sample. These solutions were loaded into a table top centrifuge (Cole Parmer Niles, IL) and spun at 6000 rpm for 10 minutes. The supernatant was discarded and the precipitates were transferred to an aluminum pan and dried in an oven at 100° C. until constant weight. The solubility was calculated and expressed as the weight of soluble solids per 100 grams of flour on dry weight basis.

### Protein Content and Solubility Measurement:

The nitrogen content of flour powders was analyzed and the total protein content was then calculated using a multiplication factor of 6.25 on the nitrogen content. Protein solubility was determined by making up aqueous solutions containing 20% flours (dry basis). After adequate mixing, the solutions were centrifuged to fully separate the precipitates (insoluble fraction) and the supernatant (soluble fraction). The resultant supernatant was analyzed for its nitrogen content. Protein content in the supernatant was then calculated based on nitrogen content using the factor of 6.25. Protein solubility is defined as the amount of protein in supernatant divided by the amount of protein in the whole solution.

### DE-Value Measurement:

Dextrose equivalent (DE) was measured using the method reported in “Y. Rong, M. Sillick, C. M. Gregson. Determination of dextrose equivalent value and number average molecular weight of maltodextrin by osmometry. Journal of Food Science, 2009, 74 (1), pp. C33-C40.)”. After centrifugation of thermally treated koji rice solution, the supernatant was collected for osmometry analysis.

### Viscosity Measurements:

Flow viscosity at different solid contents of flours on dry basis was measured at 65° C. using the Anton Paar MCR302 Rheometer (Anton Paar USA Inc., Ashland, VA). All samples were fully hydrated before measurement and concentric cylinder was used.

### Retained Oil Content:

Time-domain nuclear magnetic resonance (TD-NMR, Minispec mq20, Bruker, Billerica, USA) was used for oil content measurement. Calibration was made with neat flavor oils. Spray dry and extrusion prototypes were analyzed in triplicates and an average was reported.

### Glass Transition Temperature:

Glass Transition Temperature (Tg) measurements were conducted on a TA Instruments Differential Scanning calorimeter Q2000 (TA Instruments, New Castle, DE). Small samples (˜ 10 mg) were sealed in hermetic Tzero pans. The program consists of the following steps: equilibrate at −20° C. for 5 minutes, ramp to 100° C. at 10° C./min, cooling to −20° C., hold isothermal at −20° C. for 5 min and ramp to 100° C. at 10° C./min. The glass transition temperature was taken as the inflection point on the second heating ramp (rescan). Each sample was run in duplicate and the average is reported.

### Example 1: Preparation of Soluble Koji Rice Flour

Rice flour (Ingredion, NJ, USA) and koji rice flour (Kohsei Industrial Co., LTD, Japan) were analyzed for moisture content and protein content. A mixture of 90 grams koji rice flour or rice flour, and 210 grams of water was prepared by adding the respective flour to pre-heated water at 70° C. with agitation using a propeller mixer. The mixture had a solid content of 15% and 27% on a dry basis for rice flour and koji rice flour, respectively. To avoid quick viscosity build up, the respective flour was added slowly during a period of 30 min to allow time for starch gelatinization and hydrolysis. After all powder was added, the batch was kept at 70° C. with agitation for 4 hours. The viscosity of the mixture decreased over time as a result of starch and protein breakdown into smaller molecules. After incubation for 4 hours, the pH of the solution was adjusted to 4.0. Then the temperature was increased and kept at 80° C. for 10 minutes to inactivate enzymes. Soluble koji rice flour at higher solid contents was also prepared following the same procedures as described above. A series of rice solutions at solids content of 15%, 27%, 32%, 36%, and 40% on were obtained for viscosity characterization.

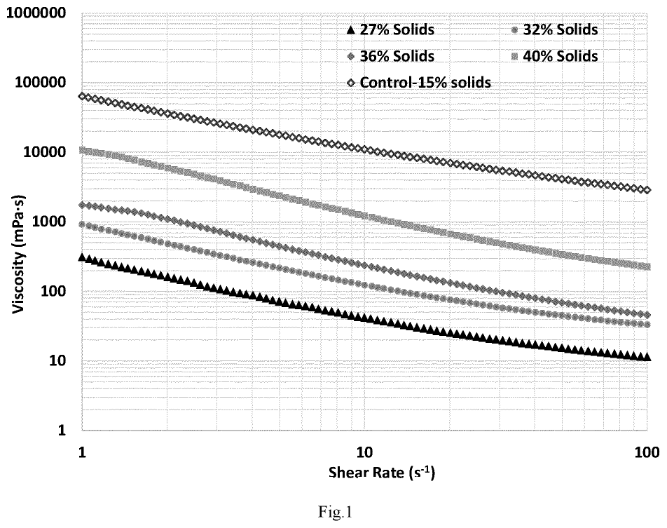

FIG. 1 shows the flow viscosity of thermally treated flour solutions. It can be observed that the control of rice flour (non-koji rice flour) at 15% solids content had the highest viscosity, whereas koji rice flour solutions at higher solids contents showed much lower viscosities. This suggests substantial breakdown of starch into smaller molecules in the koji rice flour upon thermal treatment

Table 1 shows the overall flour solubility and the solubility of proteins in flours. After thermal treatment, koji rice flour showed a solubility of 70-90% at solid contents ranging from 27-40%. As koji rice flour comprises proteins at a content of 8.3%, a moisture content of 8.5%, and <2% of lipid, the remaining starch is dominant. Therefore, starch is largely hydrolyzed during the thermal incubation described above. Moreover, measured protein solubility of both koji rice flour and rice flour (non-koji rice flour) is below 15%, whereas protein solubility of thermally treated koji rice flour increased to 30-34% suggesting partial hydrolysis of proteins in koji rice flour upon the thermal treatment.

TABLE 1
Solubility, DE-value and viscosity of thermally
treated rice flour and koji rice flour

| | | | | DE of | | |
|---|---|---|---|---|---|---|
| | | Flour | Protein | soluble | Viscosity | |
| Samples | Description | solubility | solubility | fraction | (65° C., 50 s⁻¹) | |
| A | Rice flour at | N/A | <15%¹⁾ | N/A²⁾ | 4110 | mPas |
| | 15% solids | | | | | |
| | (control) | | | | | |
| B | Koji rice | 89% | 34% | 27 | 15 | mPas |
| | flour at 27% | | | | | |
| | solids | | | | | |
| C | Koji rice | 84% | N/A | N/A | 45 | mPas |
| | flour at 32% | | | | | |
| | solids | | | | | |
| D | Koji rice | 80% | 30% | 22 | 69 | mPas |
| | flour at 36% | | | | | |
| | solids | | | | | |
| E | Koji rice | 70% | N/A | N/A | 343 | mPas |
| | flour at 40% | | | | | |
| | solids | | | | | |

¹⁾The protein content in the solution is below detection limit.
²⁾N/A measurement was not performed.

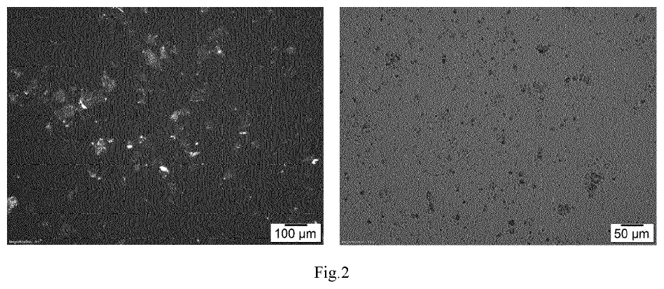

FIG. 2 shows microphotographs of koji rice flour before and after thermal treatment. Strong birefringence was observed for koji rice flour before treatment indicating semi-crystalline structure of starch granules. After thermal treatment, birefringence completely disappeared suggesting full gelatinization of starch.

In summary, both starch and proteins in koji rice flour are broken down into smaller molecules during thermal incubation resulting in higher solubility and lower viscosity. The resulting soluble koji rice flour can be used as clean label encapsulation carrier.

### Example 2: Preparation of Spray Dried Orange Flavor with Koji Rice Flour

Samples F-H were made with a batch size of 20 kg. The mixtures were prepared by adding koji rice flour to pre-heated water at 70° C. under agitation in a steam jacketed kettle equipped with scrape surface agitator. To avoid quick viscosity build up, koji rice flour was added slowly during a period of 30 min to allow time for starch gelatinization and hydrolysis. After all powder was added, the batch was kept at 70° C. under agitation for 4 hours. The viscosity of the mixture decreased over time as a result of starch and protein breakdown into smaller molecules. After incubation for 4 hours, the brix of the solution was measured using a refractometer. The pH of the solution was adjusted to 4.0 and the temperature was increased and kept at 80° C. for 10 minutes to inactivate enzymes. The resultant solution was transferred to a spray dryer feed tank transferred to a steam jacked kettle and heated to 65° C. under agitation. Then orange flavor oil (20% w/w of the payload) was added to the solution and mixed for 10 min to form a pre-emulsion. The resultant coarse emulsion was passed through a two-stage high pressure Gaulin M12 homogenizer (Manton-Gaulin Company, Boston, MA, USA) at 14 MPa for the first stage and 1.4 MPa for the second stage. Finally the homogenized emulsion was spray-dried with a box type dryer (Ernest D. Menold Inc., Lester, PA, USA) equipped with high-pressure nozzle atomizer. The atomization pressure was set at 7 MPa with inlet and outlet air temperatures of 180° C. and 80° C., respectively. The resultant powders were analyzed for their oil content.

Table 2 shows the oil content in spray-dried powder with soluble koji rice flour as carrier. Thermally treated non-koji rice flour (control) showed very high viscosity and was not able to be homogenized or sprayed. In contrast, thermally treated koji rice flour was successfully spray dried with orange oil. Oil retention greater than 85% was achieved indicating good encapsulation performance. This demonstrates that thermally treated (soluble) koji rice flour can be used as spray dry carrier without the need for additional emulsifiers. In particular, as partially hydrolyzed proteins in koji rice flour can serve as effective emulsifiers.

TABLE 2
Oil content and oil retention of spray-dried orange flavor.

| Samples | Description | Observation | Oil content | Oil retention |
|---|---|---|---|---|
| F | rice flour at 15% | Failed¹⁾ | N/A | N/A |
| | solids (control) | | | |
| G | koji rice flour at | Successful²⁾ | 18.0% | 90.0% |
| | 27% solids | | | |
| H | koji rice flour at | Successful | 17.6% | 88.0% |
| | 36% solids | | | |

¹⁾The batch is unable to homogenize and spray due to extremely high viscosity.
²⁾The batch is processed successfully without noticeable homogenization and spray issues.

### Example 3: Preparation of Spray-Dried Orange Flavor with Blend of Koji Rice Flour and Rice Flour

Blends of koji rice flour and rice flour (non-koji rice flour; Ingredion, Bridgewater, NJ, USA) at different ratios (1:1 and 1:2) were also evaluated for spray dry encapsulation. Samples were made with a batch size of 20 kg for each blend. The mixtures were prepared by adding the blended flours to pre-heated water at 70° C. with agitation in a steam jacketed kettle equipped with scrape surface agitator. To avoid quick viscosity build up, the flour blend was added slowly during a period of 30 min to allow time for starch gelatinization and hydrolysis. After all powder was added, the batch was kept at 70° C. with agitation for 4 hours. The viscosity of the mixture reduces over time as a result of starch and protein breakdown into smaller molecules. After incubation for 4 hours, the brix of the solution was measured using a refractometer as an indicator of degree of hydrolysis.

The pH of the solution was adjusted to 4.0 and then the temperature was increased and kept at 80° C. for 10 minutes to inactivate enzymes. Small samples were taken for analysis and the remaining solution was transferred to a spray dryer feed tank transferred to a steam jacked kettle and heated to 65° C. with agitation. Then orange flavor oil (20% w/w of the payload) was added to the solution and mixed for 10 min to form a pre-emulsion. The resultant coarse emulsion was passed through a two-stage high pressure Gaulin M12 homogenizer (Manton-Gaulin Company, Boston, MA, USA) at 14 MPa for the first stage and 1.4 MPa for the second stage. Finally the homogenized emulsion was spray dried with a box type dryer (Ernest D. Menold Inc., Lester, PA, USA) equipped with high-pressure nozzle atomizer. The atomization pressure was set at 7 MPa with inlet and outlet air temperatures of 180° C. and 80° C., respectively. The resultant powders were analyzed for their oil content.

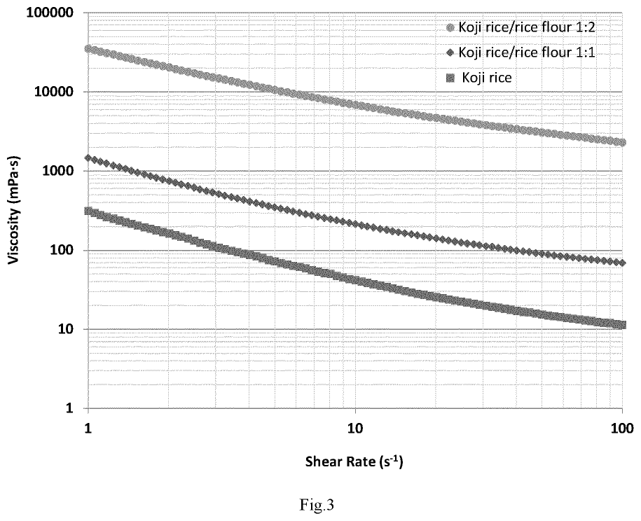

FIG. 3 shows the flow viscosity of koji rice flour and blends of koji rice with rice flour (non-koji rice flour) at different ratios.

Table 3 shows the oil retention of spray dried orange oil using blends of koji rice flour and rice flour (non-koji rice flour) as carrier. At a ratio of 1:2, the viscosity of thermally treated rice blend is too high to be processed for spray dry encapsulation. At ratio of 1:1, thermally treated rice blend was successfully spray dried with orange oil and high oil retention (>85%) was achieved. This demonstrate that soluble koji rice flour can be used in combination with rice flour (non-koji rice flour) as spray dry carrier.

TABLE 3
Oil content and oil retention of spray dried orange flavor.

| | | Viscosity | | | Oil | Oil |
|---|---|---|---|---|---|---|
| Samples | Description | (65° C., 50 s⁻¹) | | Observation | content | retention |
| I | Thermally treated | 90 | mPas | Successful¹⁾ | 17.3% | 86.5% |
| | blend of koji rice | | | | | |
| | flour and rice flour | | | | | |
| | at 1:1, solid content | | | | | |
| | 27% | | | | | |
| J | Thermally treated | 3084 | mPas | Failed²⁾ | N/A | N/A |
| | blend of koji rice | | | | | |
| | flour and rice flour | | | | | |
| | at 1:2, solid content | | | | | |
| | 27% | | | | | |

¹⁾The batch is processed successfully without noticeable homogenization and spray issues.
²⁾The batch is unable to homogenize and spray due to extremely high viscosity.

### Example 4: Preparation of Spray Dried Vegetarian Process Flavor with Koji Rice and Pea Protein

It has been surprisingly found that a blend of soluble koji rice flour and non-animal proteins can not only act as a carrier material but also at the same time imparts a certain flavor to the composition via Maillard reaction which takes place during the heating process. Blends of soluble koji rice flour and pea protein (PurisPea 870H, Cargill, MN, USA) at a ratio of 1:1 was evaluated for spray dry encapsulation of vegetarian process flavor. Samples were made with a batch size of 20 kg. The powder blend (koji rice flour and pea protein) was added to pre-heated water at 70° C. with agitation in a steam jacketed kettle equipped with scrape surface agitator. The solid content of the batch was 20% to avoid viscosity build up quickly, powder was added slowly during a period of 30 min to allow time for gelatinization and hydrolysis. After all powder was added, the batch was kept at 70° C. under agitation for 2 hours. The viscosity of the mixture reduced over time as a result of starch and protein breakdown into smaller molecules. Then, ingredients for vegetarian process flavor beef type were added to the kettle with agitation. These ingredients are reducing sugars, amino acids, lipids, etc. The total solid content of the batch including koji rice flour, pea protein, and process flavor ingredients was 50%. The batch was heated to 121° C. for 1 hour to promote Maillard type reactions and then cooled down to room temperature for spray drying. It should be noted that amino acids broken down from koji rice flour and pea protein were also expected to contribute to the Maillard reaction.

A control sample of vegetarian process flavor beef type was also made without adding koji rice flour and pea protein. Briefly, raw materials including reducing sugars, amino acids, lipids, etc. were added to a steam jacketed kettle equipped with scrape surface agitator. The batch was heated to 121° C. for 1 hour to and then cooled down to room temperature for spray drying.

The reaction pastes were passed through a two-stage high pressure Gaulin M12 homogenizer (Manton-Gaulin Company, Boston, MA, USA) at 14 MPa for the first stage and 1.4 MPa for the second stage. Finally the homogenized emulsion was spay dried with a box type dryer (Ernest D. Menold Inc., Lester, PA, USA) equipped with high-pressure nozzle atomizer. The atomization pressure was set at 7 MPa with inlet and outlet air temperatures of 180° C. and 80° C., respectively. Sensory evaluation at iso-load was conducted in base of salty water and the results indicated that the sample made with koji rice flour and pea protein has greater fatty umami taste and stronger sulfur notes than the control. The sensory results are given in Table 4 below.

TABLE 4
Sensory evaluation of vegetarian process flavor beef type

| | | Powder | |
|---|---|---|---|
| Samples | Description | observation | Sensory |
| K | Without koji rice | Sticky, low yield | Fatty mouthfeel, |
| | flour and pea | | weaker sulfur aroma |
| | protein | | |
| L | With koji rice flour | Powder with good | Fatty mouthfeel, |
| | and pea | flowability | stronger sulfur aroma |
| | protein | | and umami taste |

1. A powdered composition comprising:
a) from 40 to 95% of a carrier comprising a soluble flour, wherein:
i. the flour has a solubility of greater than or equal to 50% and less than 99%, when measured at a flour concentration of 10% w/w in an aqueous solution;
ii. the soluble flour has a viscosity of less than or equal to 400 mPa's, when measured at 65° C. and shear rate of 50 s⁻¹, and a flour concentration of 30% w/w in an aqueous solution; and
b) from 5 to 60% of at least one active ingredient,
the percentages being defined by weight, relative to the total weight of the composition.

2. The composition of claim 1, wherein the composition comprises from 50 to 80% of the carrier.

3. The composition of claim 1, wherein the composition comprises from 10 to 20% of the at least one active ingredient.

4. The composition of claim 1, wherein the at least one active ingredient comprises a flavor oil.

5. The composition of claim 1, wherein the soluble flour is soluble rice flour.

6. The composition of claim 1, wherein the soluble flour is obtained by partial hydrolysis of a non-soluble flour.

7. The composition of claim 1, wherein the at least one active ingredient is encapsulated within the carrier.

8. The composition of claim 1, wherein the soluble fraction of the soluble flour shows a DE-value of greater than 10.

9. The composition of claim 1, wherein the carrier further comprises a food material selected from the group consisting of non-soluble flours, non-soluble rice flour, non-animal proteins, pea protein, soluble fibers, inulin and/or gum arabic, and any mixture thereof.

10. A method for the preparation of the powdered composition according to claim 1, comprising the steps of:
a. partially hydrolyzing a non-soluble flour by endogenous or exogenous enzymatic hydrolysis to obtain a soluble flour;
b. preparing a blend of a carrier comprising the soluble flour obtained in step a), at least one active ingredient, and water; and
c. spray-drying or extruding the blend obtained in step b) to obtain the powdered composition.

11. The method of claim 10, wherein the exogenous enzymatic hydrolysis in step a) is performed by adding starch-hydrolyzing enzymes and optionally protein-hydrolyzing enzymes to the non-soluble flour.

12. The method of claim 10, wherein the endogenous enzymatic hydrolysis in step a) is performed by thermally treating a non-soluble flour that endogenously comprises starch-hydrolyzing enzymes and optionally protein-hydrolyzing enzymes.

13. The method of claim 12, wherein the flour is koji rice flour.

14. A flavored article comprising the composition according to claim 1.

15. The flavored article of claim 14, wherein the flavored article is selected from the group consisting of beverage dry mixes, hot beverages, sweet goods, and savory goods.

16. The composition of claim 1, wherein the at least one active ingredient comprises orange flavor oil.

17. The composition of claim 1, wherein the soluble flour is soluble koji rice flour.

18. The composition of claim 1, wherein the soluble flour is obtained by the partial enzymatic hydrolysis of starch and proteins within the non-soluble flour.

19. The composition of claim 1, wherein the soluble fraction of the soluble flour shows a DE-value of greater than 20.

20. The method of claim 10, wherein the endogenous enzymatic hydrolysis in step a) is performed by thermally treating a non-soluble flour that endogenously comprises starch-hydrolyzing enzymes and optionally protein-hydrolyzing enzymes at a temperature of from 50 to 85° C.
